(19) United States
(12) Patent Application Publication
(10) Pub. No.: US 2025/0277478 A1
(43) Pub. Date: Sep. 4, 2025

(54) MODULAR FUEL INJECTOR

(71) Applicant: CLEAN AIR POWER GT LIMITED, Melton Mowbray, Leicestershire (GB)

(72) Inventors: Dan SKELTON, Melton Mowbray, Leicestershire (GB); Ed NEWMAN, Melton Mowbray, Leicestershire (GB); Neil SULLY, Bispham, Lancashire (GB)

(21) Appl. No.: 18/863,781

(22) PCT Filed: May 9, 2023
(86) PCT No.: PCT/GB2023/051214

§ 371 Date: Nov. 7, 2024

(30) Foreign Application Priority Data
May 9, 2022 (GB) 2206767.2

(51) Int. Cl. F02M 61/04; F02M 61/16

(52) U.S. Cl. CPC F02M 61/04; F02M 61/16

(57) ABSTRACT

A modular fuel injector (100) is provided. The modular fuel injector (100) comprises a housing (102) comprising a housing inlet (400), a valve port (402), and a housing outlet (404); and a valve (104) coupled to the housing (102) via the valve port (402), wherein the housing inlet (400) comprises a coupling configured to engage with an inlet insert (106) configured to engage with a fuel supply and/or the housing outlet (404) comprises a coupling configured to engage with an outlet insert (108) comprising a fuel injector tip. A fuel injection system is also provided.

### TECHNICAL FIELD

The present disclosure relates to a modular fuel injector, and a fuel injection system. In particular, the disclosure relates to a modular fuel injector comprising a housing having a housing inlet comprises a coupling for receiving an inlet insert configured to engage with a fuel supply and/or a housing outlet comprises a coupling configured to engage with an outlet insert comprising a fuel injector tip.

### BACKGROUND

Greenhouse gas emissions from internal combustion engines (ICEs) contribute to anthropogenic climate change. To reduce greenhouse gas emissions related to ICEs, fossil fuels will likely be replaced by alternative fuels.

Such alternative fuels may include biomethane, hydrogen, and ammonia. However, these alternative fuels are more complicated to use than fossil fuels. In particular, in the prior art, gas injectors have been provided for port injection. However, there are numerous problems with only using port injection, including back fire risk and limited controllability.

Injectors capable of carrying more complicated alternative fuels such as biomethane, hydrogen and ammonia are required as an enabler to allow a move to low carbon fueled ICEs. Such ICEs are expected to take a significant proportion of the diesel, gasoline and natural gas ICE market and will be applicable to automotive, marine, construction, off-highway, mining and generator markets.

The inventors have appreciated the need for a modular injector which may easily be adapted to different engines and allows for application of the modular injector to a large range of applications and engine types.

The inventors have also appreciated the need for an injector capable of direct injection when used with hydrogen or other low carbon fuels.

### SUMMARY OF THE DISCLOSURE

The present disclosure provides a modular fuel injector and a fuel injection system for direct injection of a fuel, as defined in the appended claims, to which reference should now be made.

According to a first aspect of the present disclosure, there is provided a modular fuel injector. The fuel injector comprises a housing comprising a housing inlet, a valve port, and a housing outlet; and a valve coupled to the housing via the valve port. The valve comprises a valve inlet in fluid communication with the housing inlet; a valve outlet in fluid communication with the housing outlet; a valve opening disposed between the valve inlet and the valve outlet; and valve means disposed within the valve. The valve is configurable between a closed position, in which the valve means closes the valve opening, and an open position, in which the valve opening is open, placing the valve inlet and the valve outlet into fluid communication. The housing inlet comprises a coupling configured to engage with an inlet insert configured to engage with a fuel supply and/or the housing outlet comprises a coupling configured to engage with an outlet insert comprising a fuel injector tip.

The modular fuel injector of the present disclosure is suitable for direct injection, in particular for direct injection of hydrogen, ammonia, and/or biomethane.

The modular fuel injector of the present disclosure enables a control valve/injector to be used as a direct injector, in particular for hydrogen. By providing a housing inlet and/or a housing outlet having a coupling, the modular fuel injector may function with a wide range of engines and fitments.

In other words, the modular fuel injector adapts a prior art control valve/injector in to a direct injector that can be used in a wide range of engines, including both traditional engine designs and innovative engine designs. The wide range of engines include, but are not limited to, rotary engines, free piston engine, turbine engine, and opposed piston engines. In addition, the modular fuel injector may be used in catalytic engines, or in fuel cells.

By providing at least one coupling, the modular injector may easily be adapted to a wide range of applications. For example, if at least the housing inlet comprises a coupling, by providing an appropriate inlet insert, the modular injector may be adapted to different types of gas or fluid connections. If at least the housing outlet comprises a coupling, by providing an appropriate outlet insert, fitment into different applications may easily be provided. As such, by providing a housing outlet having a coupling, the outlet insert may easily be changed to adapt the modular injector to performance requirements.

Outlet inserts may differ in diameter, shape and length to fit into different engines. The outlet insert comprising a fuel injector tip may be adapted to vary flow direction and shape as well as to suit the cylinder head fitment. Flow may be adjusted by providing one, or more, holes, slots or other openings. This enables the fuel to be directed where it is required in the engine.

An outer shape of the outlet insert may also be adapted to suit different engine fitments—end type sealing (such as in gasoline injector), shoulder sealing (such as in diesel injector) or any other type.

Optionally, the modular fuel injector may comprise two or more valves, and two or more corresponding valve ports. For example, the housing may comprise two valve ports, and two corresponding valves. The two (or more) valve ports may be connected in parallel or the two (or more) valve ports may be connected in series.

A modular fuel injector having two valves and two valve ports may be provided for a modular fuel injector configured for use with two different fuels.

Optionally, the two or more valves may be independently controlled and/or configured. That is, while the two or more valves may be identical, they may also differ, either structurally or in the way in which they are controlled and/or configured.

Optionally or alternatively, the valve ports may be identical, or they may differ. For example, the valve ports may be provided on a same side of the housing, or two valve ports may be provided on diametrically opposed sides of the housing.

The modular fuel injector comprising two or more valves, and two or more corresponding valve ports, may be combined, in any technically possible combination, with other features of the first aspect.

Optionally, the housing inlet comprises a coupling configured to engage with an inlet insert and the housing outlet comprises a coupling configured to engage with an outlet insert. Advantageously, by providing a modular injector having both a housing inlet comprising a coupling and a housing outlet comprising a coupling, the modular injector provides changeable features both at the inlet and the outlet of the core injector, i.e. the housing and the valve, may be adapted to a wide range of applications.

Optionally, the modular injector comprises an inlet insert and/or an outlet insert.

Optionally, the, or a, inlet insert is integral with the housing. Advantageously, the outlet insert may be more likely to be adapted to a specific application, whereas the inlet insert may be adaptable to different fuels/cylinder connectors only. As such, adaptability of the outlet may be more important, whereas a limited number of modular injector variants having different inlet inserts may be sufficient to cover all applications. Alternatively, the, or a, outlet insert is integral with the housing.

Optionally, the housing inlet and the housing outlet are substantially aligned along a longitudinal axis of the housing. In other words, the housing inlet may be provided on a first longitudinal end of the modular injector, and the housing outlet may be provided on the second longitudinal end of the modular injector, in such a way that they are aligned along a longitudinal axis of the housing. Advantageously, in this way, the modular injector may be easily integrated into current fuel supply systems within given design constraints.

Optionally, a flow path through the modular injector from the housing inlet to the housing outlet diverges from the longitudinal axis of the housing.

Further optionally, the valve is arranged such that a flow path through the valve diverges from the longitudinal axis of the housing thus diverging the flow path through the modular injector from the longitudinal axis of the housing. Advantageously, in this way, the flow path of the modular injector may be controlled by defining the flow path through the valve, thus making the modular injector yet further adaptable.

Optionally, a longitudinal axis of the valve is at an angle relative to the longitudinal axis of the housing. Advantageously, this may allow for the flow path to be easily diverted from the longitudinal axis of the housing.

Optionally, the angle relative to the longitudinal axis is from 5° to 90°, further optionally from 20° to 75°, yet further optionally from 35° to 60°. Optionally, the angle relative to the longitudinal axis is about 45°. Advantageously, the valve may easily be connected to the valve port when provided at an angle.

For modular injectors comprising two or more valve ports and two or more valves, each valve may be provided at an angle relative to the longitudinal axis of the housing. Alternatively, only one or some of the two or more valves may be provides at an angle. If more than one valve is provided at an angle, the valves may be provided at a same angle, or they may be provided at different angles.

Optionally, the modular injector further comprises a seal between the valve and the housing for sealing an inlet side of the valve from an outlet side of the valve. Advantageously, the seal between the valve and the housing ensures that the only flow path through the modular injector is through the valve. In this way, the modular injector may precisely control fuel flow. This may enable the modular injector to be used for direct injection of fuels such as hydrogen and ammonia.

Optionally, the modular injector further comprises a non-return valve for preventing fluid flow through the housing outlet into the housing. Advantageously, the non-return valve protects the modular injector from combustion. Further optionally, if the modular injector comprises the outlet insert, the non-return valve is provided in the outlet insert. Advantageously, in this way, the number of components that need attaching to the modular injector is reduced.

Optionally, the modular injector further comprises an insulator configured to thermally insulate the valve from the, or an, outlet insert. Advantageously, the insulator may be made of ceramic. The insulator may be an O-ring. As will be appreciated by the person skilled in the art, the insulator may be formed of any suitable material, and may be provided in any suitable shape or form.

Optionally, the valve and the valve port comprise corresponding threads for coupling the valve and the valve port. Advantageously, the valve and the valve port may easily be connected via a screw-in connection such as a threaded connection using corresponding threads. Additionally, a threaded connection may easily be undone.

Further optionally, the modular injector further comprises a valve O-ring for sealedly coupling the valve and the valve port. Advantageously, sealedly coupling the valve and the valve port may enable improved control of fluid flow through the modular injector.

Optionally, the, or each, coupling comprises an O-ring for sealedly coupling the housing inlet and the inlet insert or an O-ring for sealedly coupling the housing outlet and the outlet insert. Advantageously, sealedly coupling the inlet insert to the housing inlet and/or the outlet insert to the housing outlet may enable improved control of fluid flow through the modular injector.

Optionally, the, or each, O-ring is made of a low carbon steel. The low carbon steel may have a carbon content of 0.05% to 0.25% by weight. Alternatively, the, or each, O-ring may be made of a stainless steel. Alternatively, the, or each, O-ring may be made of a ceramic material.

Optionally, the coupling comprises a thread. Advantageously, the coupling being a screw-in connection, e.g. by providing a thread, may allow for easy connection. Additionally, a threaded connection may easily be undone.

Further optionally, the thread is provided on an outside of the housing. Advantageously, by providing the thread on an outside of the housing, a sealed connection may easily be provided.

The thread on an outside of the housing may be configured to engage at least one of: a corresponding thread of the inlet insert, a corresponding thread of the outlet insert, and a corresponding thread of a nut. If the housing inlet comprises a coupling for receiving an inlet insert configured to engage with a fuel supply, the external thread may be configured to engage a corresponding thread of the inlet insert. If the housing outlet comprises a coupling for receiving an outlet insert configured to engage an outlet insert comprising a fuel injector tip, the external thread may be configured to engage a corresponding thread of the outlet insert. If the housing inlet or housing outlet comprises a thread on an outside of the housing, it may be configured to engage a corresponding thread of a nut. The nut may be configured to be used together with an olive-type seal.

Alternatively, the thread may be provided on an inside of the housing. The thread on an inside of the housing may be configured to engage at least one of: a corresponding thread of the inlet insert, and a corresponding thread of the outlet insert. If the housing inlet comprises a coupling for receiving an inlet insert configured to engage with a fuel supply, the internal thread may be configured to engage a corresponding thread of the inlet insert. If the housing outlet comprises a coupling for receiving an outlet insert configured to engage an outlet insert comprising a fuel injector tip, the internal thread may be configured to engage a corresponding thread of the outlet insert.

In some alternative embodiments, instead of a thread, the coupling comprises at least one of: at least one slot for engaging a corresponding projection of the inlet insert or the outlet insert; and at least one projection for engaging a corresponding slot of the inlet insert or the outlet insert. The slot and/or projection may have any suitable shape. The projection may be articulated and biased, i.e. it may be translatable in a radial direction against the biasing force to allow the projection to engage with the slot. In the biased position, the projection may be secured in the slot to couple the housing to the inlet insert or outlet insert.

Optionally, the at least one slot is configured to interlock with the corresponding projection of the inlet insert or outlet insert and/or the at least one projection is configured to interlock with the corresponding projection of the inlet insert or outlet insert.

For example, such an interlocking coupling of at least one projection and at least one slot may comprise a portion of a bayonet fitting, configured to engage with a corresponding portion of a bayonet fitting provided on an inlet insert or an outlet insert. A portion of a bayonet fitting may be a L-shaped slot, or a pin.

In some alternative embodiments, the coupling comprises at least one of: a snap-fit coupling portion for engaging a corresponding snap-fit coupling portion of the fuel supply or the fuel distributor; and a push-fit coupling portion for engaging a corresponding push-fit coupling portion of the fuel supply or the fuel distributor.

Optionally, the valve element is a ball valve element. The valve may further comprise: a valve seat surrounding the valve opening, a spring arranged to urge the ball valve element onto the valve seat to close the valve opening, and a drive pin having a first end and a second end, the drive pin being aligned with the valve opening. In the closed position, the ball valve element is held in the valve seat by the spring, closing the valve opening, and in the open position, the first end of the drive pin extends through the valve opening to push the ball valve element away from the valve seat, opening the valve opening.

Advantageously, such a valve may provide reliable performance and improved control. In particular, the provision of a ball valve element is advantageous since the reliability of the valve to form a seal is not dependant on the tolerances of other components. This reduces the effect of component tolerances, straightness, flatness, perpendicularity, etc, interacting to reduce the reliability of the valve, In addition, the use of a ball valve element removes the need for precisely engineered straight component or components with precise angles, which may be particularly susceptible to, e.g., hydrogen embrittlement where the valve element is used to control the flow of hydrogen, and/or damage during manufacture, assembly, and use.

Optionally, at least one of the spring, ball valve element, valve seat, and first end of the drive pin includes a hard surface treatment. Wear experienced by a ball valve element is generally uniform and the effectiveness of the seal can advantageously improve during the use of the valve assembly as the ball valve element is worn to the shape of the valve seat. By providing a hard surface treatment for the components of the valve which are most likely to suffer from war, the valve is particularly suitable for use with dry, or liquid free, fluids such as hydrogen or ammonia without the need for additional lubricants.

The hard surface treatment may comprise a hard coating applied to the surface of the at least one of the spring, ball valve element, valve seat, and first end of the drive pin.

The surface of one or more components may be coated using any suitable coating technique. For example, the coating of hard material may be applied by sputtering, physical vapour deposition, or dip coating.

The hard coating may comprise at least one of an oxide, a nitride, a carbide, a boride, and an oxide. For example, the hard coating may comprise silicon nitride. The hard coating may comprise a carbon based material. For example, the hard coating may comprise diamond-like carbon (DLC).

Optionally, the valve is a solenoid valve. A default position of the solenoid valve may be closed.

Optionally, at least a portion of the housing is shaped to provide engaging surfaces for a retaining mechanism configured to retain the modular injector in an engine.

Advantageously, by providing a housing which may be retained, e.g. clamped on either end of the housing, retaining forces such as clamping forces, which may interfere with valve performance, are not exerted on the valve.

Further optionally, the modular injector further comprises a retaining mechanism configured to engage with said engaging surfaces.

Optionally, the retaining mechanism may be a clamping mechanism.

According to a second aspect there is provided a fuel injector. The fuel injector comprises a housing comprising a housing inlet, a valve port, and a housing outlet; and a valve coupled to the housing via the valve port. At least a portion of the housing is shaped to provide engaging surfaces for a retaining mechanism configured to retain the injector in an engine. The valve comprises a valve inlet in fluid communication with the housing inlet; a valve outlet in fluid communication with the housing outlet; a valve opening disposed between the valve inlet and the valve outlet; and valve means disposed within the valve. The valve is configurable between a closed position, in which the valve means closes the valve opening, and an open position, in which the valve opening is open, placing the valve inlet and the valve outlet into fluid communication. The housing inlet being configured to engage with a fuel supply and the housing outlet being a fuel injector tip.

Advantageously, by providing such a fuel injector having a housing for receiving a valve, a standard valve may be made suitable for use in a variety of engines, in particular direct injection engines. The engaging surfaces advantageously enabling the fuel injector to be retained within the engine without subjecting the valve to large direct forces which may distort the valve and reduce the efficacy thereof.

Optionally, the fuel injector further comprises a retaining mechanism configured to engage with the engaging surfaces of the housing.

According to a third aspect of the present disclosure, there is provided a fuel injection system for direct injection of a fuel. The system comprises a source of pressurised fuel, and a modular fuel injector according to the first aspect or the second aspect, the source of pressurised fuel being connected to the housing inlet.

Optionally, the source of pressurised fuel comprises at least one of: a source of hydrogen; a source of ammonia; and a source of natural gas.

Optionally, the valve is configured to operate from 100 to 500,000 kPa, or higher. Optionally, the valve is configured to operate from 100 to 200,000 kPa. Optionally, the valve is configured to operate from 100 to 100,000 kPa. Optionally, the valve is configured to operate from 100 to 30,000 kPa. Optionally, the valve is configured to operate up to 6,000 kPa. Optionally, the valve is configured to operate up to 4,000 kPa.

It will be appreciated that features described in relation to one aspect of the present disclosure may also be applied equally to all of the other aspects of the present disclosure. Features described in relation to the first aspect of the present disclosure may be applied equally to the second aspect and/or the third aspect of the present disclosure and vice versa.

### BRIEF DESCRIPTION OF DRAWINGS

The disclosure will be further described, by way of example only, with reference to the accompanying drawings, in which:

FIG. 1 shows a side view of an example modular injector;

FIG. 2 shows a perspective view of the example modular injector of FIG. 1;

FIG. 3 shows top and bottom views of the example modular injector of FIGS. 1 and 2;

FIG. 4 shows a cross-sectional view of the example modular injector of FIGS. 1, 2, and 3;

FIG. 5 shows an exploded cross-sectional view of the example modular injector of FIGS. 1 to 4.

### DETAILED DESCRIPTION OF DRAWINGS

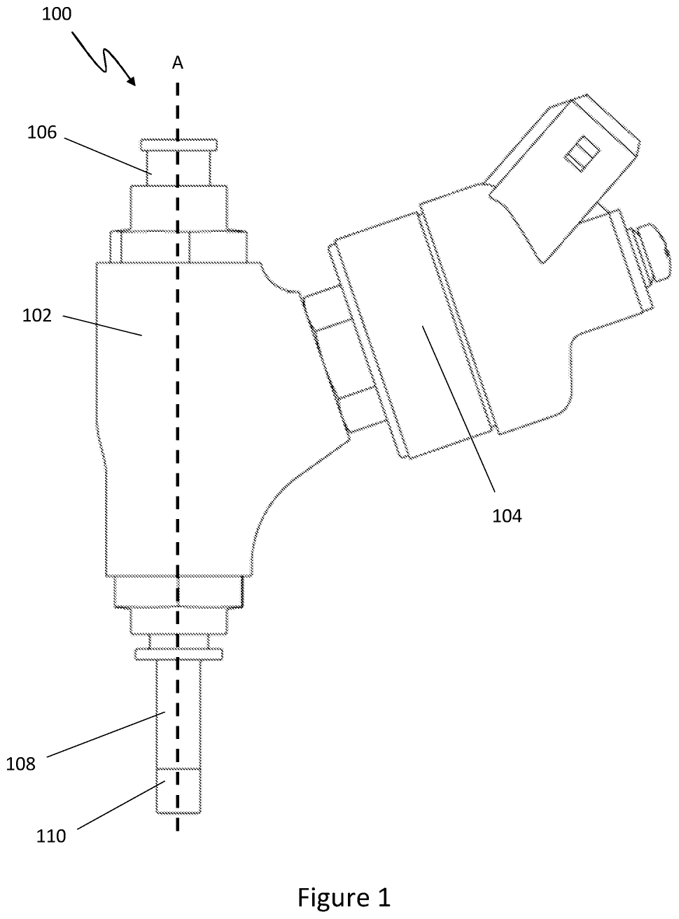

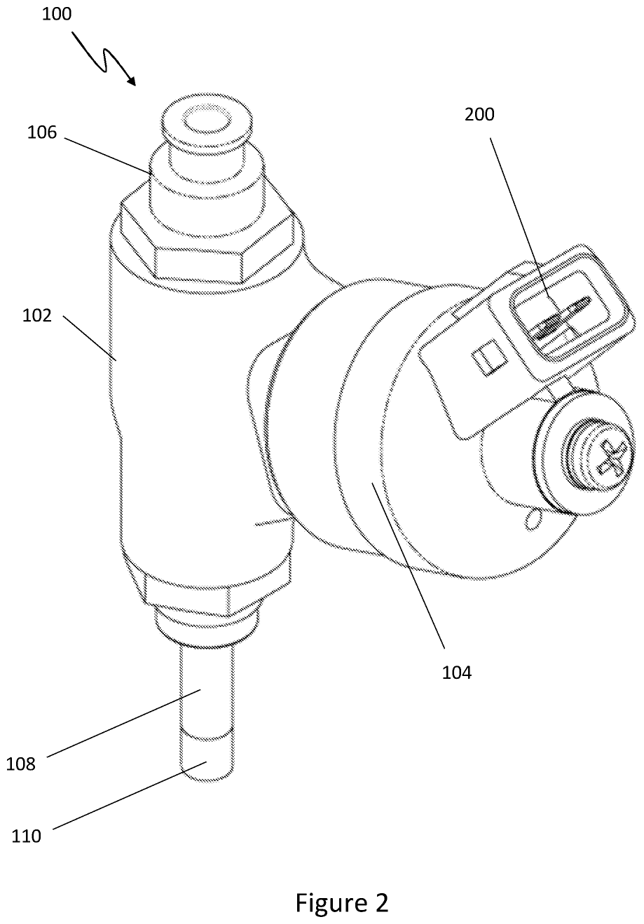

FIG. 1 shows a side view, and FIG. 2 shows a perspective view, of a modular injector 100, comprises a housing 102, a valve 104 coupled to the housing 102, an inlet insert 106 coupled to the housing 102, and an outlet insert 108 coupled to the housing 102. The inlet insert 106 is configured to engage with a fuel supply, and the outlet insert 108 comprises a fuel injector tip 110. The fuel injector tip 110 is configured to provide a spray pattern which is adapted for a specific engine application. Similarly, a length of the outlet insert 108 and a diameter of the outlet insert 108 are adapted for the specific engine application.

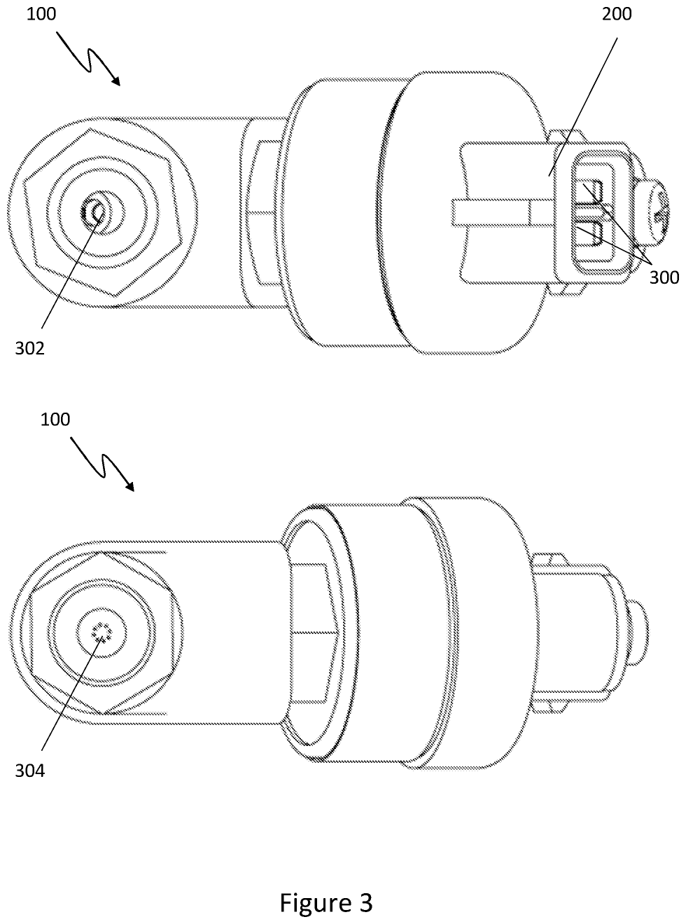

The valve comprises a socket 200, having a plurality of pins 300 (shown in FIG. 3) for engaging a controller configured to control activation of the valve 108. The fuel injector tip 110 comprises a plurality of holes 304 in a circular pattern, in a bottom surface of the fuel injector tip 110, for providing a spray pattern adapted for the specific engine application.

As will be appreciated, the fuel injector tip may comprise a plurality of holes arranged in any suitable shape, as dictated by the particular use case. In addition, the shape of each hole may not be circular, but rather any suitable shape, again as dictated by the particular use case. Furthermore, the orientation and placement of the plurality of holes may not be arranged about the longitudinal axis of the fuel injector tip, but rather may be offset to any side.

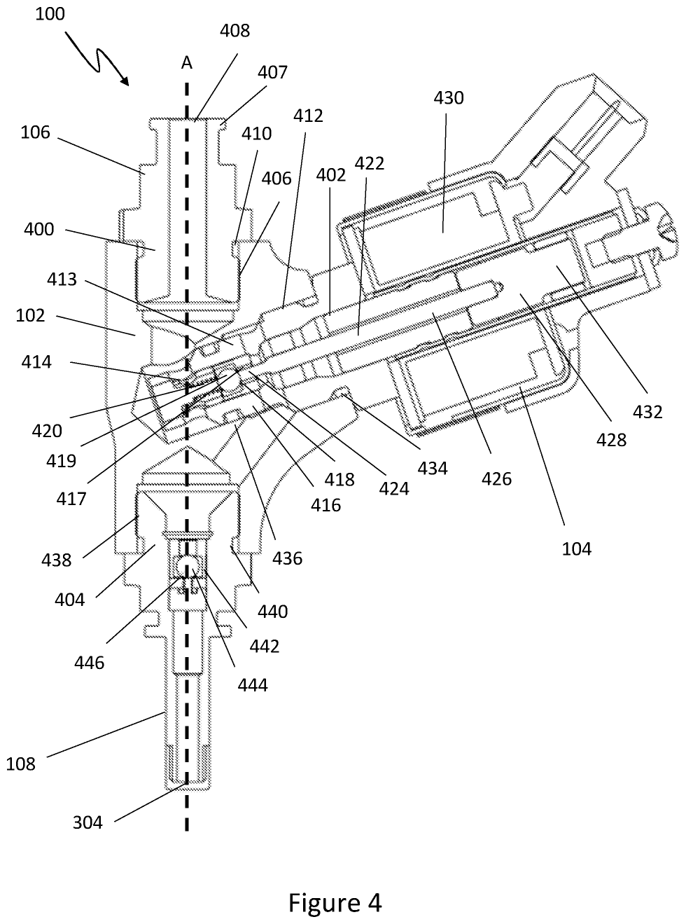

As shown in FIG. 4, the housing 102 comprises three openings: a housing inlet 400, a valve port 402, and a housing outlet 404.

The housing 102 extends along a longitudinal axis A, and the housing inlet 400 and housing outlet 404 are aligned along the longitudinal axis A. On an inside of the housing 102, the housing inlet 400 comprises a coupling 406, which is an internal thread, engaged with an external thread of the inlet insert 106. On an inlet end, the inlet insert 106 comprises a connector 407 for engaging a fuel source, and an inlet opening 408 for receiving the fuel.

Between the housing inlet 400 and the inlet insert 106, there is a gap 410. In some applications, for example if the fuel is hydrogen, the gap 410 may accommodate an O-ring.

The valve port 402 is provided at an angle of about 60 degrees relative to the longitudinal axis A. On an inside of the housing 102, the valve port 402 comprises a coupling 412, which is an internal thread, engaged with an external thread of the valve 104.

The valve 104 comprises a valve housing 413. The valve housing 413 includes a valve inlet 414 through which fuel may enter the valve 104, and a valve outlet 416 through which fuel may exit the valve 104. The valve housing 413 further includes a valve opening 417 disposed between the valve inlet 414 and the valve outlet 416.

The valve opening 417 is in the form of a circular opening. A valve seat 418 is provided about the circumference of the valve opening 417. The valve 104 further comprises a ball valve element 419 disposed within the valve housing 413. The ball valve element 419 comprises a sphere of silicon nitride. The diameter of the ball valve element 419 is larger than the diameter of the valve opening 417.

The valve 104 further comprises a spring 420 disposed adjacent the ball valve element 419, the spring 420 being arranged to urge the ball valve element 419 onto the valve seat 418 to close the valve opening 417. The spring 420 is a compression spring.

The valve 104 further comprises a drive pin 422, the drive pin 422 being in the form of an elongate rod having a first end 424 and a second end 426. The diameter of the first end 424 of the drive pin 422 is less than the diameter of the valve opening 417 such that the first end 424 of the drive pin 422 can pass through the valve opening 417.

The valve 104 is a solenoid valve, which further comprises an armature 428 disposed at, and attached to, the second end 426 of the drive pin 422. The valve 104 further comprises a coil 430 surrounding the armature 428. The armature 428 is formed from a ferromagnetic material. The armature 428 includes a rear potion 432 having a reduced diameter compared to the rest of the armature 428.

Between the valve port 402 of the housing 102 and the valve 104, the modular injector 100 further comprises an O-ring 434 for sealing the modular injector 100. The modular injector 100 further comprises an O-ring 436 between the valve 104 and the housing 102, to sealedly separate the valve inlet 414 and the valve outlet 416.

On an inside of the housing 102, the housing outlet 404 comprises a coupling 438, which is an internal thread, engaged with an external thread of the outlet insert 108. On an outlet end, the outlet insert 108 comprises the plurality of holes 304. Between the housing outlet 404 and the outlet insert 108, there is a gap 440. In some applications, for example if the fuel is hydrogen, the gap 440 may accommodate an O-ring.

The outlet insert 108 further comprises a non-return valve 442, which prevents fluid flow from the outlet insert 108 to the valve 104. The non-return valve 442 comprises a ball 444 and a spring 446 for biasing the ball 444 to a default position of the non-return valve 442.

In use, when the inlet insert 106 is connected to a pressurised source of fuel, such as hydrogen, the fuel flows along a flow path along the longitudinal axis A via the housing inlet 400 and towards the valve inlet 414. In a default position, the valve 104 is closed, as the ball valve element 419 is biased against the valve seat 418 by the spring 420 to seal the valve opening 417.

When it is desired to directly inject the fuel into an engine, the solenoid of the valve 104 is energised so that the armature 428 is actuated to move the drive pin 422, so that the first end 424 of the drive pin 422 passes through the valve opening 417 to push the ball valve element 419 off the valve seat 418, against the biasing force of the spring 420.

Pushing the ball valve element 419 off the valve seat 418 enables the fuel to flow from the valve inlet 414 to the valve outlet 416. The fuel may thus flow from the valve outlet 416 through the housing outlet 404 and via the non-return valve 442 into the outlet insert 108 comprising the fuel injector tip 110. The fuel exits the modular injector 100 via the holes 304 of the fuel injector tip 110 to provide a desired spray pattern.

Once the solenoid of the valve 104 is de-energised, the biasing force of the spring 420 (together with the fuel pressure of the fuel) urges the ball valve element 419 back onto the valve seat 418 to close the valve opening 417, thus preventing fuel flow from the valve inlet 414 to the valve outlet 416. At the same time, the non-return valve 442 prevents fluid flow from the outlet insert 108 through the housing outlet 404 into the modular injector 100.

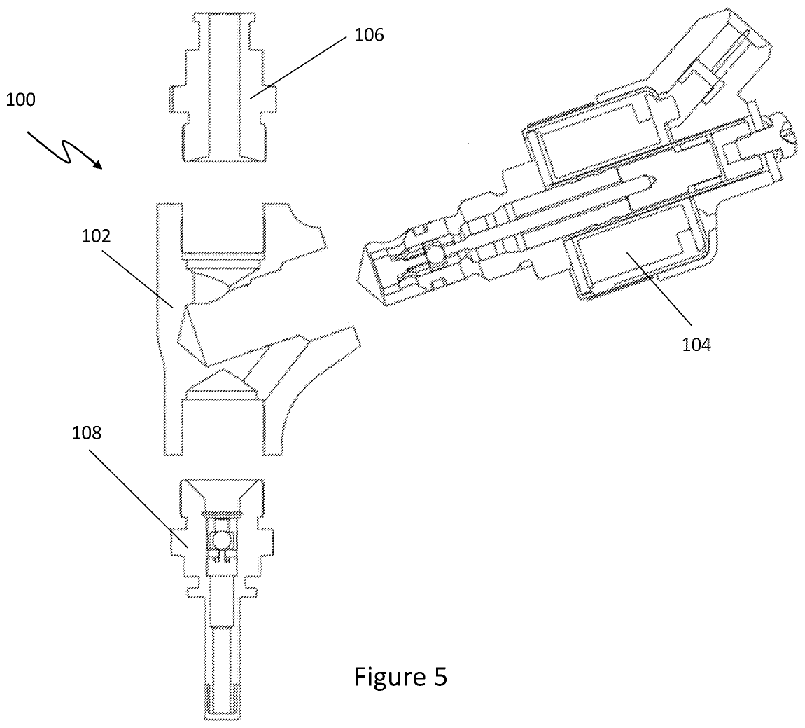

FIG. 5 shows, in cross-section, how the components of the modular injector 100 fit together. The modular injector comprises the, central, housing 102, the valve 104 which may be coupled to the housing 102, the inlet insert 106 which may be coupled to the housing 102, and the outlet insert 108 coupled to the housing 102.

1.-24. (canceled)

25. A modular fuel injector, comprising:
a housing comprising a housing inlet, a valve port, and a housing outlet; and
a valve coupled to the housing via the valve port, the valve comprising:
a valve inlet in fluid communication with the housing inlet;
a valve outlet in fluid communication with the housing outlet;
a valve opening disposed between the valve inlet and the valve outlet; and
valve means disposed within the valve,
wherein the valve is configurable between a closed position, in which the valve means closes the valve opening, and an open position, in which the valve opening is open, placing the valve inlet and the valve outlet into fluid communication,
wherein the housing inlet comprises a coupling configured to engage with an inlet insert configured to engage with a fuel supply and/or the housing outlet comprises a coupling configured to engage with an outlet insert comprising a fuel injector tip.

26. A modular fuel injector according to claim 25, wherein the housing inlet comprises a coupling configured to engage with an inlet insert and the housing outlet comprises a coupling configured to engage with an outlet insert.

27. A modular fuel injector according to claim 25, further comprising an inlet insert and/or an outlet insert.

28. A modular fuel injector according to claim 25, wherein the housing inlet and the housing outlet are substantially aligned along a longitudinal axis of the housing.

29. A modular fuel injector according to claim 28, wherein a flow path through the modular injector from the housing inlet to the housing outlet diverges from the longitudinal axis of the housing.

30. A modular fuel injector according to claim 29, wherein the valve is arranged such that a flow path through the valve diverges from the longitudinal axis of the housing thus diverging the flow path through the modular injector from the longitudinal axis of the housing.

31. A modular fuel injector according to claim 29, wherein a longitudinal axis of the valve is at an angle relative to the longitudinal axis of the housing, optionally wherein the angle is from 5° to 90°, optionally from 20° to 75°, optionally from 35° to 60°, optionally about 45°.

32. A modular fuel injector according to claim 25, further comprising a seal between the valve and the housing for sealing an inlet side of the valve from an outlet side of the valve.

33. A modular fuel injector according to claim 25, further comprising a non-return valve for preventing fluid flow through the housing outlet into the housing, optionally, if the modular injector comprises the outlet insert, the non-return valve is provided in the outlet insert.

34. A modular fuel injector according claim 25, further comprising an insulator configured to thermally insulate the valve from the, or an, outlet insert.

35. A modular fuel injector according to claim 25, wherein the housing inlet coupling comprises an O-ring for sealedly coupling the housing inlet and the inlet insert and/or the housing outlet coupling comprises an O-ring for sealedly coupling the housing outlet and the outlet insert.

36. A modular fuel injector according to claim 35, wherein the, or each, O-ring is made of a low carbon steel having a carbon content of 0.05% to 0.25% by weight, or a stainless steel, or a ceramic material.

37. A modular fuel injector according claim 25, wherein the or each coupling comprises a thread.

38. A modular fuel injector according to claim 37, wherein the thread is provided:
on an outside of the housing and configured to engage at least one of:
a corresponding thread of the inlet insert,
a corresponding thread of the outlet insert, and
a corresponding thread of a nut; or
on an inside of the housing and configured to engage at least one of:
a corresponding thread of the inlet insert, and
a corresponding thread of the outlet insert.

39. A modular fuel injector according to claim 25, wherein the coupling comprises at least one of:
at least one slot for engaging a corresponding projection of the inlet insert or the outlet insert; and
at least one projection for engaging a corresponding slot of the inlet insert or the outlet insert.

40. A modular fuel injector according to claim 25, wherein the valve element is a ball valve element and the valve further comprises:
a valve seat surrounding the valve opening,
a spring arranged to urge the ball valve element onto the valve seat to close the valve opening, and
a drive pin having a first end and a second end, the drive pin being aligned with the valve opening,
wherein in the closed position, the ball valve element is held in the valve seat by the spring, closing the valve opening, and in the open position, the first end of the drive pin extends through the valve opening to push the ball valve element away from the valve seat, opening the valve opening.

41. A modular fuel injector according to claim 25, wherein at least a portion of the housing is shaped to provide engaging surfaces for a retaining mechanism configured to retain the modular injector in an engine.

42. A modular fuel injector according to claim 41, further comprising a retaining mechanism configured to engage with said engaging surfaces.

43. A fuel injection system for direct injection of a fuel, the system comprising:
a source of pressurised fuel, and
a modular fuel injector according to claim 25, the source of fuel being connected to the housing inlet.

44. A fuel injection system according to claim 43, wherein the source of a fuel comprises at least one of: a source of hydrogen; a source of ammonia; and a source of natural gas.
